(19) United States
(12) Patent Application Publication
(10) Pub. No.: US 2024/0218108 A1
(43) Pub. Date: Jul. 4, 2024

(54) Polyurea and Method of Making Using an Amine Compound

(71) Applicant: SI Group, Inc., The Woodlands, TX (US)

(72) Inventor: Qiang Luo, Houston, TX (US)

(21) Appl. No.: 18/398,342

(22) Filed: Dec. 28, 2023

Related U.S. Application Data
(60) Provisional application No. 63/580,009, filed on Sep. 1, 2023.
(60) Provisional application No. 63/435,840, filed on Dec. 29, 2022.

(51) Int. Cl. C08G 18/32; C08G 18/10

(52) U.S. Cl. CPC C08G 18/325; C08G 18/10

(57) ABSTRACT

The present disclosure is directed to a method of synthesizing a polyurea, a polyurea, a coating containing the polyurea, and a polyurea system. The method comprises: providing a mixture of an isocyanate compound comprising a diisocyanate and an amine compound comprising a diamine wherein at least one amine group of the diamine is a secondary amine and heating the mixture to a temperature to effect a reaction between the isocyanate compound and the amine compound. The amine compound has the following structure:

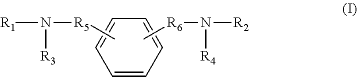

wherein R₁ and R₂ are independently hydrogen, alkyl or aryl, R₃ and R₄ are independently hydrogen or alkyl, and R₅ and R₆ are independently a direct bond or a divalent radical.

### CROSS-REFERENCE TO RELATED APPLICATIONS

The present application claims filing benefit of U.S. Provisional Patent Application No. 63/435,840 having a filing date of Dec. 29, 2022 and U.S. Provisional Patent Application No. 63/580,009 having a filing date of Sep. 1, 2023, both of which are hereby incorporated by reference in their entirety.

### BACKGROUND OF THE DISCLOSURE

Polyureas have been used extensively for a variety of applications, such as adhesives, coatings, foams, etc., in many industries. Typically, polyureas are synthesized by reacting a polyisocyanate with an amine. However, primary polyamines may react very rapidly to produce polyurea. In this regard, certain traditional methods of forming polyurea may not include desirable reaction conditions. For instance, when formed rapidly, application of a composition for forming a polyurea, such as for use as a coating, may have to be done in an urgent and calculated manner. Furthermore, certain other traditional diamines may have a general bulky structure. In this regard, such structure may negatively impact the mechanical properties, such as abrasion resistance, weathering, etc. of the polyurea which may make it undesirable for particular applications.

As such, a need continues to exist for an improved polyurea having a balance of properties and an improved method of making such a polyurea.

### SUMMARY OF THE DISCLOSURE

In accordance with one embodiment of the present disclosure, a method of synthesizing a polyurea is disclosed. The method comprises: providing a mixture of an isocyanate compound comprising a diisocyanate and an amine compound comprising a diamine wherein at least one amine group of the diamine is a secondary amine and heating the mixture to a temperature to effect a reaction between the isocyanate compound and the amine compound. The amine compound has the following structure:

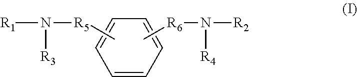

wherein R₁ and R₂ are independently hydrogen, alkyl or aryl, R₃ and R₄ are independently hydrogen or alkyl, and R₅ and R₆ are independently a direct bond or a divalent radical.

In accordance with another embodiment of the present disclosure, a polyurea is disclosed. The polyurea is formed from an isocyanate compound comprising a diisocyanate and an amine compound comprising a diamine wherein at least one amine group of the diamine is a secondary amine. The amine compound has the following structure:

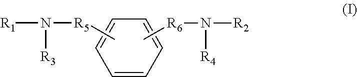

wherein R₁ and R₂ are independently hydrogen, alkyl or aryl, R₃ and R₄ are independently hydrogen or alkyl, and R₅ and R₆ are independently a direct bond or a divalent radical.

In accordance with another embodiment of the present disclosure, a coating containing the aforementioned polyurea is disclosed.

In accordance with another embodiment of the present disclosure, a polyurea system is disclosed. The polyurea system comprises an isocyanate compound comprising a diisocyanate and an amine compound comprising a diamine wherein at least one amine group of the diamine is a secondary amine. The amine compound has the following structure:

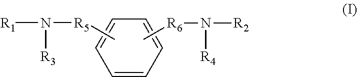

wherein R₁ and R₂ are independently hydrogen, alkyl or aryl, R₃ and R₄ are independently hydrogen or alkyl, and R₅ and R₆ are independently a direct bond or a divalent radical.

### BRIEF DESCRIPTION OF THE DRAWINGS

FIG. 1 is a graph comparing the reactivity (heat flow vs. temperature) of N,N-bis-(1,4-dimethylpentyl)-p-phenylenediamine and a commercial amine with an isocyanate in forming a polyurea of certain samples of Example 1.

FIG. 2 is a bar graph comparing the shear moduli of polyurea of certain samples of Example 1 containing N,N-bis-(1,4-dimethylpentyl)-p-phenylenediamine or 4,4′-methylenebis[N-sec-butylaniline] based on varying curing times and temperatures.

### DETAILED DESCRIPTION

It is to be understood by one of ordinary skill in the art that the present discussion is a description of exemplary embodiments only and is not intended as limiting the broader aspects of the present disclosure.

Generally speaking, the present disclosure is directed to the use of amine compounds, typically used as amine antioxidants, for the synthesis of a polyurea. In this regard, the present disclosure is directed to a polyurea, a prepolyurea composition, a polyurea system for forming a polyurea, and a method of forming a polyurea. In general, a polyurea is a polymerization product of the reaction of one or more amine compound(s) (or monomer(s)) with one or more isocyanate compound(s) (or monomer(s)). Without intending to be limited, the present inventor has discovered that controlling the structure of the amine compound can optimize the reactivity with the isocyanate compound. For instance, without intending to be limited, such optimization may be obtained due to the specific groups and corresponding size of such groups on the nitrogen atoms of the amine compound. In turn, the method as disclosed herein may provide preferable reaction conditions for synthesizing the polyurea.

In addition, the polyurea may have certain benefits due to being inherently fire retardant, compared to certain polyurethanes. Also, the polyurea may exhibit desired heat resistance and mechanical properties, such as strength, hardness, etc. For instance, the polyurea may exhibit a desired lap shear modulus, which may provide an indication regarding the bond strength of the polyurea for a given substrate. As indicated herein, in one embodiment, the substrate for purposes of testing may be an aluminum substrate in one embodiment. In general, the lap shear modulus may be determined in accordance with ASTM D3163-01 (2014) at room temperature and the method as further defined herein within the examples.

In this regard, in one embodiment, the polyurea may have a lap shear modulus of 40 MPa or more, such as 45 MPa or more, such as 50 MPa or more, such as 55 MPa or more, such as 60 MPa or more, such as 65 MPa or more. The lap shear modulus may be 150 MPa or less, such as 140 MPa or less, such as 130 MPa or less, such as 120 MPa or less, such as 110 MPa or less, such as 100 MPa or less, such as 95 MPa or less, such as 95 MPa or less, such as 90 MPa or less, such as 85 MPa or less, such as 80 MPa or less, such as 75 MPa or less, such as 70 MPa or less, such as 65 MPa or less. Such lap shear modulus may be based on an aluminum substrate, in particular wherein the polyurea was synthesized at a temperature of 130° C. and a reaction time of 2 hours.

In another embodiment, the polyurea may have a lap shear modulus of 25 MPa or more, such as 30 MPa or more. The lap shear modulus may be 100 MPa or less, such as 95 MPa or less, such as 95 MPa or less, such as 90 MPa or less, such as 85 MPa or less, such as 80 MPa or less, such as 75 MPa or less, such as 70 MPa or less, such as 65 MPa or less, such as 60 MPa or less, such as 55 MPa or less, such as 45 MPa or less, such as 40 MPa or less, such as 35 MPa or less. Such lap shear modulus may be based on an aluminum substrate, in particular wherein the polyurea was synthesized at a temperature of 90° C. and a reaction time of 24 hours.

In a further embodiment, the polyurea may have a lap shear modulus of 5 MPa or more, such as 10 MPa or more. The lap shear modulus may be 15 MPa or less. Such lap shear modulus may be based on a polyvinyl chloride substrate, in particular wherein the polyurea was synthesized at a temperature of 60° C. and a reaction time of 24 hours.

The polyurea may have a certain tensile strength as determined in accordance with ASTM D412-16 (2021). For instance, the tensile strength may be 25 kg/cm² or more, such as 50 kg/cm² or more, such as 75 kg/cm² or more, such as 100 kg/cm² or more, such as 150 kg/cm² or more, such as 200 kg/cm² or more, such as 250 kg/cm² or more, such as 300 kg/cm² or more, such as 350 kg/cm² or more, such as 400 kg/cm² or more, such as 450 kg/cm² or more, such as 500 kg/cm² or more, such as 550 kg/cm² or more, such as 600 kg/cm² or more. The tensile strength may be 1000 kg/cm² or less, such as 950 kg/cm² or less, such as 900 kg/cm² or less, such as 850 kg/cm² or less, such as 800 kg/cm² or less, such as 750 kg/cm² or less, such as 700 kg/cm² or less, such as 650 kg/cm² or less, such as 600 kg/cm² or less, such as 550 kg/cm² or less, such as 500 kg/cm² or less, such as 450 kg/cm² or less, such as 400 kg/cm² or less, such as 350 kg/cm² or less, such as 300 kg/cm² or less, such as 250 kg/cm² or less, such as 200 kg/cm² or less, such as 150 kg/cm² or less, such as 100 kg/cm² or less.

The polyurea may have a certain Shore D hardness as determined in accordance with ASTM D2240-15 (2021). For instance, the Shore D hardness may be 40 or more, such as 45 or more, such as 50 or more, such as 55 or more, such as 60 or more, such as 65 or more, such as 70 or more, such as 75 or more, such as 80 or more, such as 85 or more, such as 90 or more. The Shore D hardness may be 100 or less, such as 95 or less, such as 90 or less, such as 85 or less, such as 80 or less, such as 75 or less, such as 70 or less, such as 65 or less, such as 60 or less.

### Amine Compound

As indicated herein, the polyurea is formed from an amine compound. In this regard, the prepolyurea composition and the polyurea system for forming the polyurea may also include such amine compound. In synthesizing the polyurea, the amine compound, or one or more amine compounds, react with an isocyanate compound as disclosed herein.

In general, the amine compound as disclosed herein for preparing the polyurea may also typically be referred to as an amine (or aminic) antioxidant. In this regard, such compounds may have an antioxidant attribute. Regardless, the present inventor has discovered that such amine compounds may also be capable of functioning for other purposes, such as for preparing polyurea.

The amine compound may be a multiamine compound. For instance, a multiamine compound generally refers to an amine compound including two or more amine groups. In this regard, the amine compound may be a diamine, a triamine, or a mixture thereof. In one embodiment, the amine compound may be a triamine. For instance, such triamine may include three amine groups. In one particular embodiment, the amine compound may be a diamine. For instance, such diamine may include two amine groups.

The amine compound may include a primary amine, a secondary amine, a tertiary amine, or a mixture thereof. In particular, a respective amine group of an amine compound may be a primary amine, a secondary amine, a tertiary amine, or a mixture thereof. In one embodiment, the respective amine group may be a primary amine. In another embodiment, the respective amine group may be a tertiary amine. In one particular embodiment, the respective amine group may be a secondary amine. In one embodiment, at least one amine group of the amine compound may be a secondary amine. In another embodiment, each amine group of the amine compound may be a secondary amine.

When the amine compound is a diamine, in one embodiment, both amine groups may not be a primary amine in one embodiment. In another embodiment, each amine group may be a secondary amine. In a further embodiment, one amine group may be a primary amine while the other amine group may be a secondary amine. In an even further embodiment, each amine group may be a tertiary amine. In another further embodiment, one amine group may be a tertiary amine while the other amine group may be a primary amine group or a secondary amine group.

The amine compound may be an aromatic amine, an aliphatic amine, an aromatic/aliphatic amine, or a mixture thereof. In one embodiment, the amine compound may be an aromatic amine. In another embodiment, the amine compound may be an aliphatic amine. In a further embodiment, the amine compound may be an aromatic/aliphatic amine. For instance, the amine compound may include an aryl group having one or more aliphatic, such as alkyl, substituent groups bonded to at least one, such as at least two, of two or more nitrogen atoms of the amine compound.

In one embodiment, the amine compound may have the below structure of formula (I):

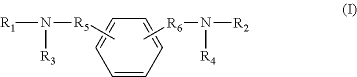

wherein
R₁ and R₂ are independently hydrogen, alkyl or aryl;
R₃ and R₄ are independently hydrogen or alkyl; and
R₅ and R₆ are independently a direct bond or a divalent radical.

In such formula (I), in one embodiment, the respective substituent groups may be bonded to different carbon atoms of the aromatic ring. For instance, in one embodiment, such respective substituent groups may be ortho, meta, or para with respect to each other. In one embodiment, they may be ortho. In another embodiment, they may be meta. In a further embodiment, they may be para.

In one embodiment, the substituent groups may be ortho with respect to each other. For instance, in particular, the amine compound may have the below structure of formula (Ia):

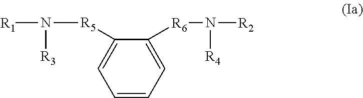

wherein
R₁ and R₂ are independently hydrogen, alkyl or aryl;
R₃ and R₄ are independently hydrogen or alkyl; and
R₅ and R₆ are independently a direct bond or a divalent radical.

In another embodiment, the substituent groups may be para with respect to each other. For instance, in particular, the amine compound may have the below structure of formula (Ib):

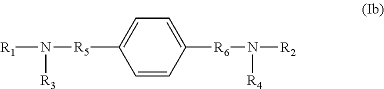

wherein
R₁ and R₂ are independently hydrogen, alkyl or aryl;
R₃ and R₄ are independently hydrogen or alkyl; and
R₅ and R₆ are independently a direct bond or a divalent radical.

As indicated above, R₁ and R₂ are independently hydrogen, alkyl or aryl. In one embodiment, R₁ is hydrogen. In another embodiment, R₁ is alkyl. In a further embodiment, R₁ is aryl. In one embodiment, R₂ is hydrogen. In another embodiment, R₂ is alkyl. In a further embodiment, R₂ is aryl. In general, in one embodiment, only one of R₁ and R₂ may be hydrogen. In another embodiment, both R₁ and R₂ are hydrogen.

As indicated above, R₃ and R₄ are independently hydrogen or alkyl. In one embodiment, R₃ is hydrogen. In another embodiment, R₃ is alkyl. In one embodiment, R₄ is hydrogen. In another embodiment, R₄ is alkyl. In general, in one embodiment, both R₃ and R₄ may be hydrogen. In another embodiment, only one of R₃ and R₄ may be hydrogen.

In addition, in one embodiment, at least one of R₁ and R₃ is not hydrogen. In this regard, R₁ is alkyl or aryl, such as alkyl, and/or R₃ is alkyl. In one embodiment, only one of R₁ and R₃ is hydrogen. Similarly, in one embodiment, at least one of R₂ and R₄ is not hydrogen. In this regard, R₂ is alkyl or aryl, such as alkyl, and/or R₄ is alkyl. In one embodiment, only one of R₂ and R₄ is hydrogen.

Regarding the alkyl, it may generally be a C₁-C₁₆ alkyl. For instance, the alkyl may be a C₁-C₁₆ alkyl, such as a C₁-C₁₄ alkyl, such as a C₁-C₁₂ alkyl, such as a C₁-C₁₀ alkyl, such as a C₁-C₈ alkyl, such as a C₁-C₆ alkyl, such as a C₁-C₄ alkyl, such as a C₁-C₈ alkyl, such as a C₁-C₂ alkyl. In this regard, the alkyl may have 1 or more, such as 2 or more, such as 3 or more, such as 5 or more, such as 8 or more carbon atoms. The alkyl may have 16 or less, such as 14 or less, such as 12 or less, such as 10 or less, such as 8 or less, such as 6 or less, such as 5 or less, such as 4 or less, such as 3 or less, such as 2 or less carbon atoms. In one embodiment, the alkyl may be a lower alkyl. For instance, the alkyl may be methyl in one embodiment.

Further, the alkyl may be linear or branched. In one embodiment, the alkyl may be linear. In another embodiment, the alkyl may be branched.

Regarding the aryl, it may be a C₃-C₁₂ aryl. In this regard, the aryl may be a C₃-C₁₂ aryl, such as a C₄-C₁₂ aryl, such as a C₆-C₁₂ aryl, such as a C₆-C₁₀ aryl, such as a C₆-C₈ aryl. For instance, the aryl may have 3 or more, such as 4 or more, such as 5 or more, such as 6 or more carbon atoms. The aryl may have 12 or less, such as 10 or less, such as 8 or less, such as 7 or less, such as 6 or less, such as 5 or less carbon atoms. In addition, in one embodiment, the aryl may be polycyclic. The polycyclic aryl may include fused, bridged, and spiro ring systems. In one particular embodiment, the aryl may be phenyl.

In one embodiment, the aforementioned alkyl may be substituted. For instance, the alkyl may be aryl substituted. Such substituent may be referred to as arylalkyl or arylkyl. Such alkyl and aryl groups may be as defined above.

In one embodiment, the aforementioned aryl may be substituted. For instance, the aryl may be alkyl substituted. Such substituent may be referred to as alkaryl. Such alkyl and aryl groups may be as defined above.

As indicated above, R₅ and R₆ are independently a direct bond or a divalent radical. In one embodiment, R₅ is a direct bond. In another embodiment, R₅ is a divalent radical. In one embodiment, R₆ is a direct bond. In another embodiment, R₆ is a divalent radical. In one embodiment, R₅ and R₆ are independently a direct bond. In another embodiment, R₅ and R₆ are independently a divalent radical.

The divalent radical may be an alkylene. For instance, the alkylene may be a C₁-C₅ alkylene, such as a C₁-C₃ alkylene, such as a C₁-C₂ alkylene, such as a C₁ alkylene. For instance, the alkylene may have 1 or more, such as 2 or more, such as 3 or more, such as 4 or more carbon atoms. The alkylene may have 5 or less, such as 4 or less, such as 3 or less, such as 2 or less carbon atoms. In one particular embodiment, the alkylene may be methylene.

In one embodiment, the amine compound may be a p-phenylenediamine based compound. For instance, in particular, the amine compound may have the below structure of formula (Ic):

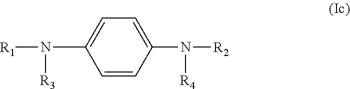

wherein
R₁ and R₂ are independently hydrogen, alkyl or aryl; and
R₃ and R₄ are independently hydrogen or alkyl.

In the aforementioned structure (Ic), the alkyl and aryl may be as defined above with respect to the structures of formulae (I), (Ia), and (Ib).

In one embodiment, the amine compound may be a triamine. For instance, the triamine may be a triazine based compound. In particular, the amine compound may have the below structure of formula (II):

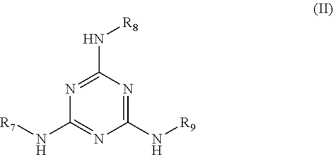

wherein R₇, R₈, and R₉ are independently alkyl or aryl.

For instance, in one embodiment, R₇ may be alkyl. In another embodiment, R₇ may be aryl. In one embodiment, R₈ may be alkyl. In another embodiment, R₈ may be aryl. In one embodiment, R₉ may be alkyl. In another embodiment, R₉ may be aryl. In one embodiment, at least two of R₇, R₈, and R₉ may be the same. In a further embodiment, all three of R₇, R₈, and Ry may be the same. In another embodiment, all three of R₇, R₈, and R₉

Regarding the alkyl, it may be a C₁-C₁₆ alkyl. For instance, the alkyl may be a C₁-C₁₆ alkyl, such as a C₁-C₁₄ alkyl, such as a C₁-C₁₂ alkyl, such as a C₁-C₁₀ alkyl, such as a C₁-C₈ alkyl, such as a C₁-C₆ alkyl, such as a C₁-C₄ alkyl, such as a C₁-C₈ alkyl, such as a C₁-C₂ alkyl. In this regard, the alkyl may have 1 or more, such as 2 or more, such as 3 or more, such as 5 or more, such as 8 or more carbon atoms. The alkyl may have 16 or less, such as 14 or less, such as 12 or less, such as 10 or less, such as 8 or less, such as 6 or less, such as 5 or less, such as 4 or less, such as 3 or less, such as 2 or less carbon atoms. In one embodiment, the alkyl may be a lower alkyl. For instance, the alkyl may be methyl in one embodiment.

Further, the alkyl may be linear or branched. In one embodiment, the alkyl may be linear. In another embodiment, the alkyl may be branched.

Regarding the aryl, it may be a C₃-C₁₂ aryl. In this regard, the aryl may be a C₃-C₁₂ aryl, such as a C₄-C₁₂ aryl, such as a C₆-C₁₂ aryl, such as a C₆-C₁₀ aryl, such as a C₆-C₈ aryl. For instance, the aryl may have 3 or more, such as 4 or more, such as 5 or more, such as 6 or more carbon atoms. The aryl may have 12 or less, such as 10 or less, such as 8 or less, such as 7 or less, such as 6 or less, such as 5 or less carbon atoms. In addition, in one embodiment, the aryl may be polycyclic. The polycyclic aryl may include fused, bridged, and spiro ring systems. In one particular embodiment, the aryl may be phenyl.

In one embodiment, the aforementioned alkyl may be substituted. For instance, the alkyl may be aryl substituted. Such substituent may be referred to as arylalkyl or arylkyl. Such alkyl and aryl groups may be as defined above.

In one embodiment, the aforementioned aryl may be substituted. For instance, the aryl may be alkyl substituted. Such substituent may be referred to as alkaryl. Furthermore, such substitution may be an aminoalkyl (i.e., nitrogen of amino bonded to carbon of aryl) or alkylamine (i.e., carbon of alkyl bonded to carbon of aryl). In one embodiment, the substitution may be aminoalkyl. In this regard, such nitrogen may have a hydrogen substituent. Such alkyl and aryl groups may be as defined above. One example of such a compound having substitutions includes N, N′, N″-tris[4-[(1,4dimethylpentyl)amino]phenyl]-1,3,5-triazine-2,4,6-triamine (CAS No. 121246-28-4).

The amine compounds that may be utilized in accordance with the present disclosure may include, but are not limited to, poly(1,2-dihydro-2,2,4-trimethylquinoline) (CAS No. 26780-96-1); N,N-bis-(1,4-dimethylpentyl)-p-phenylenediamine (CAS No. 3081-14-9); 1,4-benzenediamine, N,N′-mixed phenyl and tolyl derivatives (CAS No. 68953-84-4); N, N′, N″-tris[4-[(1,4dimethylpentyl)amino]phenyl]-1,3,5-triazine-2,4,6-triamine (CAS No. 121246-28-4); N-isopropyl-N′-phenyl-1,4-phenylenediamine (CAS No. 101-72-4); bis(2,2,6,6tetramethyl-4-piperidyl) sebacate (CAS No. 52829-07-9); bis(1,2,2,6,6pentamethyl-4-piperidyl) sebacate (CAS No. 41556-26-7); poly[6[(1, 1,3,3-tetramethylbutyl)amino]-1,3,5-triazine-2,4-diyl][2,2,6,6-tetramethyl-4piperidyl)imino]-1,6-hexanediyl[(2,2,6,6-tetramethyl-4-piperidyl)imino]]) (CAS No. 70624-18-9); 1,5,8,12-tetrakis[4,6-bis(N-butyl-N-1,2,2,6,6pentamethyl-4-piperidylamino)-1,3,5˜triazin-2-yl]-1,5,8,12-tetraazadodecane (CAS No. 106990-43-6); N-(1,4-dimethylpentyl)-1,4-benzenediamine; N-1,3-dimethylbutyl-N′-phenyl-p-phenylenediamine (CAS No. 793-24-8); N,N′-di-2-butyl-1,4-phenylenediamine (CAS No. 101-96-2); N-1-(1,4-dimethylpentyl)-1,4-benzenediamine (CAS No. 63302-43-2); m-xylylenediamine (CAS No. 1477-55-0); diethyltoluene diamine (CAS No. 68479-98-1); polyoxypropylene triamine (CAS No. 39423-51-3) or a mixture thereof.

The amine compounds of formula (I) and/or (Ia) may include, but are not limited to, poly(1,2-dihydro-2,2,4-trimethylquinoline) (CAS No. 26780-96-1); N,N-bis-(1,4-dimethylpentyl)-p-phenylenediamine (CAS No. 3081-14-9); 1,4-benzenediamine, N,N′-mixed phenyl and tolyl derivatives (CAS No. 68953-84-4); N, N′, N″-tris[4-[(1,4dimethylpentyl)amino]phenyl]-1,3,5-triazine-2,4,6-triamine (CAS No. 121246-28-4); N-isopropyl-N′-phenyl-1,4-phenylenediamine (CAS No. 101-72-4); bis(2,2,6,6tetramethyl-4-piperidyl) sebacate (CAS No. 52829-07-9); bis(1,2,2,6,6pentamethyl-4-piperidyl) sebacate (CAS No. 41556-26-7); poly[6[(1,1,3,3-tetramethylbutyl)amino]-1,3,5-triazine-2,4-diyl][2,2,6,6-tetramethyl-4piperidyl)imino]-1,6-hexanediyl[(2,2,6,6-tetramethyl-4-piperidyl)imino]) (CAS No. 70624-18-9); 1,5,8,12-tetrakis[4,6-bis(N-butyl-N-1,2,2,6,6pentamethyl-4-piperidylamino)-1,3,5-triazin-2-yl]-1,5,8, 12-tetraazadodecane (CAS No. 106990-43-6); N-(1,4-dimethylpentyl)-1,4-benzenediamine; N-1,3-dimethylbutyl-N′-phenyl-p-phenylenediamine (CAS No. 793-24-8); N,N′-di-2-butyl-1,4-phenylenediamine (CAS No. 101-96-2); N-1-(1,4-dimethylpentyl)-1,4-benzenediamine (CAS No. 63302-43-2); or a mixture thereof.

For instance, the amine compound may include N-isopropyl-N′-phenyl-1,4-phenylenediamine (CAS No. 101-72-4); 1,4-benzenediamine, N,N′-mixed phenyl and tolyl derivatives (CAS No. 68953-84-4); N,N-bis-(1,4-dimethylpentyl)-p-phenylenediamine (CAS No. 3081-14-9); N, N′, N″-tris[4-[(1,4dimethylpentyl)amino]phenyl]-1,3,5-triazine-2,4,6-triamine (CAS No. 121246-28-4); N-1,3-dimethylbutyl-N′-phenyl-p-phenylenediamine (CAS No. 793-24-8); N,N′-di-2-butyl-1,4-phenylenediamine (CAS No. 101-96-2); N-1-(1,4-dimethylpentyl)-1,4-benzenediamine (CAS No. 63302-43-2); or a mixture thereof. In one particular embodiment, the amine compound may comprise N-1,3-dimethylbutyl-N′-phenyl-p-phenylenediamine (CAS No. 793-24-8). In another particular embodiment, the amine compound may comprise N,N-bis-(1,4-dimethylpentyl)-p-phenylenediamine (CAS No. 3081-14-9).

As indicated herein, the amine compound may be a diamine. In this regard, the amine compound may include, but is not limited to, N, N′-diphenyl-p-phenylenediamine (CAS No. 74-31-7); N,N-bis-(1,4-dimethylpentyl)-p-phenylenediamine (CAS No. 3081-14-9); 1,4-benzenediamine, N,N′-mixed phenyl and tolyl derivatives (CAS No. 68953-84-4); N-isopropyl-N′-phenyl-1,4-phenylenediamine (CAS No. 101-72-4); bis(2,2,6,6tetramethyl-4-piperidyl) sebacate (CAS No. 52829-07-9); bis(1,2,2,6,6pentamethyl-4-piperidyl) sebacate (CAS No. 41556-26-7); N-(1,4-dimethylpentyl)-1,4-benzenediamine; N-1,3-dimethylbutyl-N′-phenyl-p-phenylenediamine (CAS No. 793-24-8); N, N′-di-2-butyl-1,4-phenylenediamine (CAS No. 101-96-2); N-1-(1,4-dimethylpentyl)-1,4-benzenediamine (CAS No. 63302-43-2); m-xylylenediamine (CAS No. 1477-55-0); or a mixture thereof.

As indicated herein, the amine compound may be a triamine. In this regard, the amine compound may include, but is not limited to, poly(1,2-dihydro-2,2,4-trimethylquinoline) (CAS No. 26780-96-1); N, N′,N″-tris[4-[(1,4dimethylpentyl)amino]phenyl]-1,3,5-triazine-2,4,6-triamine (CAS No. 121246-28-4); poly[6[(1,1,3,3-tetramethylbutyl)amino]-1,3,5-triazine-2,4-diyl][2,2,6,6-tetramethyl-4piperidyl)imino]-1,6-hexanediyl[(2,2,6,6-tetramethyl-4-piperidyl)imino]]) (CAS No. 70624-18-9); or a mixture thereof.

The amine compounds of formula (II) and/or (IIa) may include, but are not limited to, m-xylylenediamine (CAS No. 1477-55-0).

In one embodiment, the amine compound may include N,N-bis-(1,4-dimethylpentyl)-p-phenylenediamine (CAS No. 3081-14-9), N,N′-di-2-butyl-1,4-phenylenediamine (CAS No. 101-96-2), m-xylylenediamine (CAS No. 1477-55-0), or a mixture thereof. In one embodiment, the amine compound may include N,N-bis-(1,4-dimethylpentyl)-p-phenylenediamine (CAS No. 3081-14-9), N,N′-di-2-butyl-1,4-phenylenediamine (CAS No. 101-96-2), or a mixture thereof. In one embodiment, the amine compound may be N-bis-(1,4-dimethylpentyl)-p-phenylenediamine (CAS No. 3081-14-9). In another embodiment, the amine compound may be N,N′-di-2-butyl-1,4-phenylenediamine (CAS No. 101-96-2).

In one embodiment, the amine compound may be a sterically hindered amine compound. In this regard, the nitrogen atom may be at least partially shielded by neighboring groups. In this regard, the amine compound may include at least one benzene ring bonded to the nitrogen of at least one amine group. In one embodiment, the amine compound may include at least one benzene ring bonded to the nitrogen of at least two amine groups. In one embodiment, the amine compound may include at least one alkyl group bonded to the nitrogen of at least one amine group. In one embodiment, the amine compound may include at least one alkyl group bonded to the nitrogen of at least two amine groups. In a further embodiment, the amine compound may include at least one benzene ring and at least one alkyl group bonded to the nitrogen of at least one amine group. In one embodiment, the amine compound may include at least one benzene ring and at least one alkyl group bonded to the nitrogen of at least two amine groups.

The amine compound may have a particular weight. For instance, the molecular weight may be 120 g/mol or more, such as 130 g/mol or more, such as 140 g/mol or more, such as 150 g/mol or more, such as 160 g/mol or more, such as 170 g/mol or more, such as 180 g/mol or more, such as 190 g/mol or more, such as 200 g/mol or more, such as 210 g/mol or more, such as 220 g/mol or more, such as 230 g/mol or more, such as 240 g/mol or more, such as 250 g/mol or more, such as 260 g/mol or more, such as 270 g/mol or more, such as 280 g/mol or more, such as 290 g/mol or more, such as 300 g/mol or more, such as 325 g/mol or more, such as 350 g/mol or more, such as 375 g/mol or more, such as 400 g/mol or more, such as 425 g/mol or more, such as 450 g/mol or more, such as 475 g/mol or more, such as 500 g/mol or more, such as 550 g/mol or more, such as 600 g/mol or more, such as 650 g/mol or more, such as 700 g/mol or more. The molecular weight may be 1000 g/mol or less, such as 950 g/mol or less, such as 900 g/mol or less, such as 850 g/mol or less, such as 800 g/mol or less, such as 750 g/mol or less, such as 700 g/mol or less, such as 650 g/mol or less, such as 600 g/mol or less, such as 550 g/mol or less, such as 500 g/mol or less, such as 450 g/mol or less, such as 400 g/mol or less, such as 350 g/mol or less, such as 300 g/mol or less, such as 280 g/mol or less, such as 260 g/mol or less, such as 240 g/mol or less, such as 220 g/mol or less, such as 200 g/mol or less, such as 180 g/mol or less, such as 160 g/mol or less, such as 140 g/mol or less.

In one embodiment, the amine compound may include more than one amine compound as defined herein. For instance, the amine compound may include a mixture of amine compounds. In this regard, the amine compound may include at least two amine compounds (e.g., a first amine compound as defined herein and a second amine compound). In another embodiment, such mixture may include a third amine compound. In one embodiment, the second amine compound and the third amine compound may be as defined above. In this regard, such amine compounds may also have any of the structures as mentioned herein. For instance, each amine compound may independently have the structure of formula (I), such as (Ia), (Ib), or (Ic). In particular, each amine compound may independently have the structure of formula (Ia) or (Ic).

In one embodiment, the first amine compound may include a compound of formula (I), in particular formula (Ib) and even more particularly formula (Ic). In addition, the second amine compound may also include a compound of formula (I), in particular formula (Ia).

In this regard, in one embodiment, the amine compound may include N,N-bis-(1,4-dimethylpentyl)-p-phenylenediamine (CAS No. 3081-14-9), N,N′-di-2-butyl-1,4-phenylenediamine (CAS No. 101-96-2), or a mixture thereof in combination with m-xylylenediamine (CAS No. 1477-55-0). For instance, in one embodiment, the amine compound may be a mixture of N-bis-(1,4-dimethylpentyl)-p-phenylenediamine (CAS No. 3081-14-9) and m-xylylenediamine (CAS No. 1477-55-0). In another embodiment, the amine compound may be a mixture of N,N′-di-2-butyl-1,4-phenylenediamine (CAS No. 101-96-2) and m-xylylenediamine (CAS No. 1477-55-0).

In one embodiment, the second amine compound and/or third amine compound may not have a structure as defined above. For instance, it does not have a structure of formula (I), such as (Ia), (Ib), or (Ic), or formula (II). Instead, the second amine compound and/or third amine compound may be another amine compound as conventionally known in the art. Such second amine compound and/or third amine compound may be a multiamine, including two or more amine groups. In this regard, such amine compound may be a diamine, a triamine, or a mixture thereof. In one embodiment, such amine compound may be a triamine. For instance, such triamine may include three amine groups. In one particular embodiment, such amine compound may be a diamine. For instance, such diamine may include two amine groups.

Such amine compound may include a primary amine, a secondary amine, a tertiary amine, or a mixture thereof. In particular, a respective amine group of such an amine compound may be a primary amine, a secondary amine, a tertiary amine, or a mixture thereof. In one embodiment, the respective amine group may be a primary amine. In another embodiment, the respective amine group may be a tertiary amine. In one particular embodiment, the respective amine group may be a secondary amine.

Such amine compound may be an aromatic amine, an aliphatic amine, an aromatic/aliphatic amine, or a mixture thereof. In one embodiment, the amine compound may be an aromatic amine. In another embodiment, the amine compound may be an aliphatic amine. In a further embodiment, the amine compound may be an aromatic/aliphatic amine.

Such conventional amine compounds may include, but are not limited to a polyoxyalkylene amine (e.g., polyoxypropylene triamine). These may commonly be referred to as a polyetheramine.

These amine compounds may also include those in which the aryl group of any of the aforementioned structures may be substituted. In particular, such substitution may be on a carbon of the aryl ring of any of the aforementioned structures (I, Ia, Ib, Ic). Such aryl group may have 1 or more, such as 2 or more, such as 3 or more substitutions. The aryl group may have 4 or less, such as 3 or less, such as 2 or less substitutions. In one embodiment, the substitution may be an alkyl substituent. The alkyl substituent may be a C₁-C₁₆ alkyl. For instance, the alkyl substituent may be a C₁-C₁₆ alkyl, such as a C₁-C₁₄ alkyl, such as a C₁-C₁₂ alkyl, such as a C₁-C₁₀ alkyl, such as a C₁-C₈ alkyl, such as a C₁-C₆ alkyl, such as a C₁-C₄ alkyl, such as a C₁-C₈ alkyl, such as a C₁-C₂ alkyl. In this regard, the alkyl substituent may have 1 or more, such as 2 or more, such as 3 or more, such as 5 or more, such as 8 or more carbon atoms. The alkyl substituent may have 16 or less, such as 14 or less, such as 12 or less, such as 10 or less, such as 8 or less, such as 6 or less, such as 5 or less, such as 4 or less, such as 3 or less, such as 2 or less carbon atoms. In one embodiment, the alkyl may be a lower alkyl. For instance, the alkyl may be methyl in one embodiment. Such conventional amine compounds may include, but are not limited to alkyl diamines, such as dialkyl diamines, toluene diamines, etc. For instance, this may include 2,4-diaminotoluene, diethyl toluene diamine, etc.

In one embodiment, the polyurea may be formed from an amine compound as defined herein in combination with a second amine compound comprising a polyoxyalkylene amine (e.g., polyoxypropylene triamine) and/or an alkyl diamine, such as a toluene diamine (e.g., diethyl toluene diamine). In this regard, the second amine compound may comprise a polyoxyalkylene amine (e.g., polyoxypropylene triamine) and an alkyl diamine, such as a toluene diamine (e.g., diethyl toluene diamine). Particularly, in one embodiment, the polyurea may be formed from an amine compound as defined herein in combination with a second amine compound comprising a polyoxypropylene triamine and a diethyl toluene diamine.

In one particular embodiment, the polyurea may be formed from an amine compound as defined herein in combination with a second amine compound comprising a polyoxyalkylene amine (e.g., polyoxypropylene triamine) and a third amine compound comprising an alkyl diamine, such as a toluene diamine (e.g., diethyl toluene diamine). Particularly, in one embodiment, the polyurea may be formed from an amine compound as defined herein in combination with a second amine compound comprising a polyoxypropylene triamine and a third amine compound comprising diethyl toluene diamine.

When present as a mixture, the amount of such first amine compound and second amine compound may be within a certain ratio. For instance, the ratio of the first amine compound to the second amine compound may be 0.001 or more, such as 0.005 or more, such as 0.01 or more, such as 0.03 or more, such as 0.05 or more, such as 0.07 or more, such as 0.1 or more, such as 0.2 or more, such as 0.3 or more, such as 0.4 or more, such as 0.5 or more, such as 0.6 or more, such as 0.7 or more, such as 0.8 or more, such as 0.9 or more, such as 1 or more, such as 1.5 or more, such as 2 or more, such as 3 or more, such as 5 or more. The ratio may be 10 or less, such as 8 or less, such as 6 or less, such as 5 or less, such as 4 or less, such as 3 or less, such as 2.5 or less, such as 2 or less, such as 1.8 or less, such as 1.6 or less, such as 1.4 or less, such as 1.2 or less, such as 1.1 or less, such as 1 or less, such as 0.8 or less, such as 0.6 or less, such as 0.4 or less, such as 0.2 or less, such as 0.1 or less. In one embodiment, the aforementioned ratio may be a weight ratio. In another embodiment the aforementioned ratio may be a molar ratio. In a further embodiment, the aforementioned ratio may be an amine equivalent ratio. In a further embodiment, the aforementioned ratio may apply to a third amine compound. In an even further embodiment, the aforementioned ratio may apply to a combination of a second amine compound and a third amine compound.

Related, the first amine compound may be provided in an amount of 1 wt. % or more, such as 2 wt. % or more, such as 3 wt. % or more, such as 5 wt. % or more, such as 7 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more based on the total weight of the first amine compound and the second amine compound. The first amine compound may be provided in an amount of 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less, such as 8 wt. % or less based on the total weight of the first amine compound and the second amine compound. In one embodiment, such aforementioned weight percentages may apply to the entire mixture of amine compounds utilized. In a further embodiment, the aforementioned weight percentages may apply to a third amine compound instead of a second amine compound. In an even further embodiment, the aforementioned weight percentages may apply to a combination of a second amine compound and a third amine compound.

The second amine compound may be provided in an amount of 5 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more based on the total weight of the first amine compound and the second amine compound. The second amine compound may be provided in an amount of 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less based on the total weight of the first amine compound and the second amine compound. In one embodiment, such aforementioned weight percentages may apply to the entire mixture of amine compounds utilized.

The third amine compound may be provided in an amount of 5 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more based on the total weight of the first amine compound and the third amine compound. The third amine compound may be provided in an amount of 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less based on the total weight of the first amine compound and the third amine compound. In one embodiment, such aforementioned weight percentages may apply to the entire mixture of amine compounds utilized.

### Isocyanate Compound

As indicated herein, the polyurea is formed from an isocyanate compound. In this regard, the prepolyurea composition and the polyurea system for forming the polyurea may also include such isocyanate compound. The polyurea is formed as a polymerization product of the reaction of one or more amine compound(s) (or monomer(s)) with one or more isocyanate compound(s) (or monomer(s)).

The isocyanate compound is not necessarily limited by the present disclosure. The isocyanate compound may be a polyisocyanate. For instance, such isocyanate compounds include two or more isocyanate groups. The isocyanate compound may be di-functional or tri-functional. In one embodiment, the isocyanate compound is di-functional (i.e., a diisocyanate). In another embodiment, the isocyanate compound is tri-functional (i.e., a triisocyanate).

The isocyanate compound may be any as generally known in the art. In one embodiment, the isocyanate compound may have the general formula: OCN—B—NCO wherein B is a bivalent hydrocarbyl radical. The bivalent hydrocarbyl radical may be saturated or unsaturated. In one embodiment, it may be saturated. For instance, the radical may include a bivalent aliphatic radical in one embodiment. In another embodiment, it may be unsaturated. For instance, the radical may include a bivalent aryl radical in one embodiment. In a further embodiment, the radical may include a bivalent aliphatic radical in combination with a bivalent aryl radical.

The bivalent hydrocarbyl radical may have from 2 to 20 carbon atoms. In this regard, the bivalent hydrocarbyl radical may have 2 or more, such as 3 or more, such as 5 or more, such as 7 or more, such as 9 or more carbon atoms. The bivalent hydrocarbyl radical may have 20 or less, such as 18 or less, such as 16 or less, such as 14 or less, such as 12 or less, such as 10 or less, such as 8 or less, such as 6 or less, such as 5 or less, such as 4 or less, such as 3 or less carbon atoms.

In one embodiment, the bivalent hydrocarbyl radical may be a bivalent aliphatic radical. The bivalent aliphatic radical may be linear, branched, cyclic, or a combination thereof. For instance, in one embodiment, the radical may be a linear bivalent aliphatic radical. In another embodiment, the radical may be a branched bivalent aliphatic radical. In a further embodiment, the radical may be cyclic bivalent aliphatic radical. In a further embodiment, the radical may be a combination of a linear bivalent aliphatic radical and a cyclic bivalent aliphatic radical. For instance, B may include a combination of both of such radicals. In another embodiment, the radical may be a combination of a branched bivalent aliphatic radical and a cyclic bivalent aliphatic radical.

The cyclic bivalent aliphatic radical may be unsubstituted in one embodiment. In another embodiment, the cyclic bivalent aliphatic radical may be substituted. The cyclic bivalent aliphatic radical may have 1 or more, such as 2 or more, such as 3 or more, such as 4 or more, such as 5 or more substitutions. The cyclic bivalent aliphatic radical may have 8 or less, such as 6 or less, such as 5 or less, such as 4 or less, such as 3 or less substitutions. In one embodiment, the substitution may be an alkyl substituent. The alkyl substituent may be a C₁-C₁₆ alkyl. For instance, the alkyl substituent may be a C₁-C₁₆ alkyl, such as a C₁-C₁₄ alkyl, such as a C₁-C₁₂ alkyl, such as a C₁-C₁₀ alkyl, such as a C₁-C₈ alkyl, such as a C₁-C₆ alkyl, such as a C₁-C₄ alkyl, such as a C₁-C₈ alkyl, such as a C₁-C₂ alkyl. In this regard, the alkyl substituent may have 1 or more, such as 2 or more, such as 3 or more, such as 5 or more, such as 8 or more carbon atoms. The alkyl substituent may have 16 or less, such as 14 or less, such as 12 or less, such as 10 or less, such as 8 or less, such as 6 or less, such as 5 or less, such as 4 or less, such as 3 or less, such as 2 or less carbon atoms. In one embodiment, the alkyl may be a lower alkyl. For instance, the alkyl may be methyl in one embodiment.

In one embodiment, the bivalent aliphatic radical may be referred to as an alkylene. When cyclic, such alkylene may be referred to as a cycloalkylene. The alkylene may be a C₁-C₂₀ alkylene, such as a C₁-C₁₆ alkylene, such as a C₁-C₁₄ alkylene, such as a C₁-C₁₂ alkylene, such as a C₁-C₁₀ alkylene, such as a C₁-C₈ alkylene, such as a C₂-C₈ alkylene, such as a C₄-C₈ alkylene, such as a C₅-C₈ alkylene, such as a C₅-C₇ alkylene. The alkylene may have 1 or more, such as 2 or more, such as 3 or more, such as 4 or more, such as 5 or more, such as 6 or more, such as 7 or more, such as 8 or more carbon atoms. The alkylene may have 20 or less, such as 18 or less, such as 16 or less, such as 14 or less, such as 12 or less, such as 10 or less, such as 8 or less, such as 6 or less, such as 5 or less, such as 4 or less, such as 3 or less, such as 2 or less carbon atoms. The aforementioned definition and features may apply to each type of respective alkylene, such as a linear alkylene or a combination of a linear alkylene or branched alkylene with a cyclic alkylene.

In one embodiment, the alkylene may be hexamethylene. In another embodiment, the alkylene may be cyclohexylene. In a further embodiment, the alkylene may be a combination of a methylene and a cyclohexylene, in particular a substituted cyclohexylene (e.g., as in isophorone diisocyanate). In another further embodiment, the alkylene may include a combination of a methylene and two cyclohexylenes (e.g., as in 4,4′-diisocyanato dicyclohexylmethane).

In one embodiment, the bivalent hydrocarbyl radical may be a bivalent aryl radical. The bivalent aryl radical may be unsubstituted in one embodiment. In another embodiment, the bivalent aryl radical may be substituted. In this regard, it may include 1 or more, such as 2 or more, such as 3 or more, such as 4 or more, such as 5 or more substitutions. The radical may have 8 or less, such as 6 or less, such as 5 or less, such as 4 or less, such as 3 or less substitutions. In one embodiment, the substitution may be an alkyl substituent. The alkyl substituent may be a C₁-C₁₆ alkyl. For instance, the alkyl substituent may be a C₁-C₁₆ alkyl, such as a C₁-C₁₄ alkyl, such as a C₁-C₁₂ alkyl, such as a C₁-C₁₀ alkyl, such as a C₁-C₈ alkyl, such as a C₁-C₆ alkyl, such as a C₁-C₄ alkyl, such as a C₁-C₈ alkyl, such as a C₁-C₂ alkyl. In this regard, the alkyl substituent may have 1 or more, such as 2 or more, such as 3 or more, such as 5 or more, such as 8 or more carbon atoms. The alkyl substituent may have 16 or less, such as 14 or less, such as 12 or less, such as 10 or less, such as 8 or less, such as 6 or less, such as 5 or less, such as 4 or less, such as 3 or less, such as 2 or less carbon atoms. In one embodiment, the alkyl may be a lower alkyl. For instance, the alkyl may be methyl in one embodiment.

In one embodiment, the bivalent aryl radical may include phenylene. The phenylene may be 1,3-phenylene, 1,4-phenylene, etc. In one embodiment, the phenylene may be 1,3-phenylene. In another embodiment, the phenylene may be 1,4-phenylene. The phenylene may be unsubstituted in one embodiment. In another embodiment, the phenylene may be substituted. For instance, such substituted phenylene may be methylphenylene in one embodiment.

In addition, the bivalent aryl radical may be polycyclic. The bivalent polycyclic aryl radical may be fused, bridged, or a spiro ring system. In one embodiment, the bivalent polycyclic aryl radical may be fused. Such a fused system may include a bivalent naphthalene (e.g., 1,5-naphthalene). In another embodiment, the bivalent polycyclic aryl radical may be bridged. In one embodiment, such bridge may be an alkylene as mentioned above. Such a bridged system may include a methylene diphenyl (e.g., 4,4′-methylene diphenyl). In a further embodiment, the bivalent polycyclic aryl radical may be a spiro ring system.

In one embodiment, the bivalent hydrocarbyl radical may be a combination of a bivalent aliphatic radical and a bivalent aryl radical. Such bivalent aliphatic radical and bivalent aryl radical may be any as mentioned above. In one embodiment, the radical may include two branched C₃ alkylenes and a phenylene (e.g., as in tetramethylxylylene diisocyanate).

Examples of suitable aliphatic isocyanates include, but are not limited to, polymethylene isocyanates, such as 1,4-tetramethylene diisocyanate, 1,5-pentamethylene diisocyanate, hexamethylene diisocyanates (HDIs or HMDIs), 1,6-heptamethylene diisocyanate, 1,7-heptamethylene diisocyanate, 2,2,4-and 2,4,4-trimethylhexamethylene diisocyanate, 1,10-decamethylene diisocyanate and 2-methyl-1,5-pentamethylene diisocyanate, as well as mixtures thereof. Additional suitable aliphatic polyisocyanates include 3-isocyanatomethyl-3,5,5-trimethylcyclohexl isocyanate, bis(4-isocyanatocyclohexyl)methane, 3,3,5-trimethyl-5-isocyanato-methyl-cyclohexyl isocyanate, which is isophorone diisocyanate (IPDI), 1,4-cyclohexane diisocyanate, m-tetramethylxylene diisocyanate, 4,4′-dicyclohexlmethane diisocyanate, and hydrogenated materials such as cyclohexylene diisocyanate and 4,4′-methylenedicyclohexyl diisocyanate (HI2MDI), as well as mixtures thereof. Further suitable aliphatic isocyanates also include ethylene diisocyanate and 1,12-dodecane diisocyanate.

Examples of suitable cycloaliphatic isocyanates include, but are not limited to, cyclohexane-1,4-diisocyanate, cyclobutane-1,3-diisocyanate, cyclohexane-1,3-diisocyanate, 1-isocyanato-2-isocyanatomethyl cyclopentane, 1-isocyanato-3, 3, 5-trimethyl-5-isocyanatomethyl cyclohexane, 2,4′-dicyclohexylmethane diisocyanate, and 4,4′-dicyclohexylmethane diisocyanate, as well as mixtures thereof.

Examples of suitable aromatic isocyanates include, but are not limited to, phenylene diisocyanate, toluene diisocyanate (TDI), xylene diisocyanate, 1,5-naphthalene diisocyanate, chlorophenylene 2,4-diisocyanate, bitoluene diisocyanate, dianisidine diisocyanate, tolidine diisocyanate, aralkyl diisocyanates such as tetramethylxylyl diisocyanate, and alkylated benzene diisocyanates generally as well as mixtures thereof. Methylene-interrupted aromatic diisocyanales such as diphenylmethane diisocyanate (MDI), especially the 4,4′-isomer including alkylated analogs such as 3,3′-dimethyl-4,4′-diphenylmethane diisocyanate and polymeric methylenediphenyl diisocyanate are also suitable as well as mixtures thereof. Suitable aromatic diisocyanates which may also be used include 3,3′-dimethoxy-4,4′-bisphenylenediisocyanate, 3,3′-diphenyl-4,4′-biphenylenediisocyanate, 4,4′-biphenylene diisocyanale, 4-chloro-1,3-phenylene diisocyanate, 3,3′-dichloro-4,4′-biphenylene diisocyanate, and 1,5-naphthalene diisocyanate as well as mixtures thereof.

Particularly, the isocyanate compound, such as the diisocyanate, may include, but is not limited to, hexane diisocyanate, isophorone diisocyanate, naphthalene diisocyanate, toluene-2,4-diisocyanate, toluene-2,6-diisocyanate, methylenediphenyldiisocyanate, p-phenylenediisocyanate, meta-trimethylxylylenediisocyanate, methylene-bis(4-cyclohexylisocyanate), tetramethylxylylene diisocyanate, hydrogenated methylenediphenyldiisocyanate or a mixture thereof.

In one particular embodiment, the isocyanate compound, such as the diisocyanate, may include toluene diisocyanate, methylenediphenyldiisocyanate, or a mixture thereof. For instance, the isocyanate compound, such as the diisocyanate, may include toluene diisocyanate in one embodiment. In another embodiment, the isocyanate compound, such as the diisocyanate, may include methylenediphenyldiisocyanate.

Furthermore, it should be appreciated that the use of various oligomeric polyisocyanates (e.g., dimers, trimers, polymeric) and modified polyisocyanales (e.g., carbodiimides, uretone-imines) are also within the scope of the present disclosure. Such oligomeric or modified polyisocyanate may be of any of the isocyanates as mentioned herein. Moreover, homopolymers and prepolymers incorporating one or more of these aliphatic, cyclic, and aromatic isocyanates compounds or mixtures or reaction products thereof are suitable. In general, such prepolymer may include two or more isocyanate groups, such as two isocyanate groups, and may function as the isocyanate compound, such as the diisocyanate compound, as defined herein. Such isocyanate groups may be available for reacting with the amine compound.

In one embodiment, such oligomeric polyisocyanate may be a polymeric diisocyanate. For instance, as an example, the oligomeric polyisocyanale (or polymeric diisocyanate) may be polymeric methylenediphenyldiisocyanate.

### Polyurea

As indicated herein, the present disclosure is directed to a polyurea as well as method of making the polyurea. The polyurea may be made using the prepolyurea composition or polyurea system for making a polyurea as defined herein. As used herein, the term “polyurea system” refers to a set of chemical components that may be mixed to form an active composition for forming the polyurea. In this regard, such active composition may be cured to form the polyurea. For instance, such an active composition may include a coating composition that may applied and cured to form a coating. As used herein, the term “prepolyurea composition” refers to a mixture of chemical components that will cure, such as to form a coating when applied. Accordingly, a composition may be formed from a polyurea system by mixing the chemical components (e.g., amine compound, isocyanate compound, etc.) comprising the polyurea system. Furthermore, when a list of constituents is provided in this specification that are individually suitable for forming the components of the polyurea, a respective composition, or polyurea system as described herein, it should be understood that various combinations of two or more of those constituents, combined in a manner that would be known to those of ordinary skill in the art reading this specification, may be employed and is contemplated.

The polyurea may be formed using general techniques as known in the art. For instance, generally, the method may include providing a mixture comprising an amine compound and an isocyanate compound as defined herein. Such a mixture may also be referred to as a prepolyurea composition. In a further embodiment, the amine compound and the isocyanate compound may be provided as a polyurea system. In this regard, such a mixture is formed from the polyurea system.

In forming the polyurea, the amine compound reacts with the isocyanate compound. In one embodiment, the polyurea may be synthesized by reacting one or more amine compounds and one or more isocyanate compounds as defined herein. The polyurea may be formed, such as under conditions conducive to the formation of a polyurea. Related, the method may include mixing the compounds, such as from the polyurea system. The compounds may be provided and/or mixed under reactive conditions to initiate polymerization. In addition, the method may include heating the mixture to a temperature to effect a reaction between the amine compound and the isocyanate compound.

In one embodiment, one component may first be heated, for instance at a temperature as defined below. Thereafter, another component may be provided for reacting with the first component for forming the polyurea. The addition of such second component may be over a period of time. In another embodiment, the second component may be provided at once.

The temperature of the mixture for the reaction may be relatively low. For instance, the temperature may be 20° C. or more, such as 25° C. or more, such as 30° C. or more, such as 40° C. or more, such as 50° C. or more, such as 60° C. or more, such as 70° C. or more, such as 80° C. or more, such as 90° C. or more, such as 100° C. or more, such as 110° C. or more, such as 120° C. or more, such as 130° C. or more, such as 140° C. or more, such as 150° C. or more, such as 160° C. or more, such as 170° C. or more, such as 180ºC or more, such as 190° C. or more. The temperature may be 250° C. or less, such as 230° C. or less, such as 210° C. or less, such as 200° C. or less, such as 180ºC or less, such as 160° C. or less, such as 140° C. or less, such as 120° C. or less, such as 100° C. or less, such as 80° C. or less, such as 60° C. or less, such as 50° C. or less, such as 40° C. or less, such as 35° C. or less, such as 30° C. or less.

The reaction time is not necessarily limited by the present disclosure. For instance, the reaction time may be 0.1 hours or more, such as 0.2 hours or more, such as 0.3 hours or more, such as 0.5 hours or more, such as 0.8 hours or more, such as 1 hour or more, such as 2 hours or more, such as 3 hours or more, such as 4 hours or more, such as 5 hours or more, such as 6 hours or more, such as 8 hours or more, such as 10 hours or more, such as 12 hours or more, such as 14 hours or more, such as 16 hours or more, such as 18 hours or more, such as 20 hours or more, such as 24 hours or more, such as 28 hours or more. The reaction time may be 48 hours or less, such as 44 hours or less, such as 40 hours or less, such as 36 hours or less, such as 32 hours or less, such as 28 hours or less, such as 24 hours or less, such as 20 hours or less, such as 18 hours or less, such as 16 hours or less, such as 14 hours or less, such as 12 hours or less, such as 10 hours or less, such as 9 hours or less, such as 8 hours or less, such as 7 hours or less, such as 6 hours or less, such as 5 hours or less, such as 4 hours or less, such as 3 hours or less, such as 2 hours or less.

As indicated, the polyurea may be synthesized by reacting an amine compound, such as a diamine, and an isocyanate compound, such as a diisocyanate, via condensation. In addition, in one embodiment, the reaction may begin with reacting an amine compound with a polyurea prepolymer. In this regard, the prepolymer may be capable of undergoing further polymerization. In this regard, the prepolymer may react with the amine compound, such as the diamine. In such scenario, the prepolymer may function as the isocyanate compound, in particular the diisocyanate, as it may include two or more isocyanate groups capable of reacting with the amine groups of the diamine compound. In one embodiment, the method may include reacting an amine compound, such as a diamine, with an isocyanate compound including a polyurea prepolymer including two reactive isocyanate groups and a second diisocyanate compound.

Via the polymerization reaction, the compounds/monomers provide multiple urea linkages [—R₁₀N—C(O)—NR₁₁—], where C(O) defines a carbonyl group (C═O) and wherein R₁₀ is dictated by the amine compound utilized in the synthesis and R₁₁ is dictated by the isocyanate compound utilized in the synthesis. For instance, R₁₀ may refer to the substituent or radical between the two nitrogen atoms of the amine compound participating in the synthesis and reaction with the isocyanate compound. In this regard, R₁₀ may refer to the —R₅-phenylene-R₆-substituent of the structure of formula (I) (and corresponding structures (Ia) and (Ib) or simply the -phenylene- substituent of the structure of formula (Ic)) above. Similarly, R₁₁ may refer to the substituent or radical between the two nitrogen atoms of the isocyanate compound participating in the synthesis and reaction with the amine compound. In this regard, R₁₁ may refer to the aforementioned “B” in one embodiment.

In general, the polyurea may have a polymer backbone chain and two end-groups. In particular, the polyurea may have a linear series of covalently bonded atoms that together create the continuous chain of the polyurea wherein any other chains, long or short or both, may be regarded as being pendant. In one embodiment, the polyurea may be a linear or unbranched copolymer.

The amine compound and the isocyanate compound may be provided in a particular molar ratio. For instance, the molar ratio of the isocyanate compound to the amine compound may be 0.1 or more, such as 0.2 or more, such as 0.3 or more, such as 0.4 or more, such as 0.5 or more, such as 0.6 or more, such as 0.7 or more, such as 0.8 or more, such as 0.9 or more, such as 1 or more, such as 1.1 or more, such as 1.2 or more, such as 1.3 or more, such as 1.4 or more, such as 1.5 or more, such as 1.6 or more, such as 1.7 or more, such as 1.8 or more, such as 1.9 or more, such as 2 or more, such as 2.2 or more, such as 2.5 or more. The molar ratio may be 3 or less, such as 2.8 or less, such as 2.6 or less, such as 2.4 or less, such as 2.2 or less, such as 2 or less, such as 1.8 or less, such as 1.6 or less, such as 1.4 or less, such as 1.2 or less, such as 1.1 or less, such as 1 or less, such as 0.9 or less, such as 0.8 or less, such as 0.7 or less, such as 0.6 or less, such as 0.5 or less, such as 0.4 or less, such as 0.3 or less.

In one embodiment, such aforementioned ratio may be with respect to a first amine compound. For example, such amine compound may be one having the structure of formula (I), such as (Ia), (Ib), or (Ic), or (II). In particular, such amine compound may be one having the structure of formula (I), such as (Ia), (Ib), or (Ic), particularly formula (Ic). Furthermore, in one embodiment, such aforementioned ratio may be with respect to all amine compounds utilized in the formation of the polyurea.

The amine compound may be provided in an amount of about 3% or more, such as 5% or more, such as 10% or more, such as 15% or more, such as 20% or more, such as 25% or more, such as 30% or more, such as 35% or more, such as 40% or more, such as 45% or more, such as 50% or more, such as 55% or more, such as 60% or more, such as 65% or more, such as 70% or more, such as 75% or more, such as 80% or more, such as 85% or more, such as 90% or more. The amine compound may be provided in an amount of 95% or less, such as 90% or less, such as 85% or less, such as 80% or less, such as 75% or less, such as 70% or less, such as 65% or less, such as 60% or less, such as 55% or less, such as 50% or less, such as 45% or less, such as 40% or less, such as 35% or less, such as 30% or less, such as 25% or less, such as 20% or less, such as 15% or less, such as 10% or less, such as 8% or less. In one embodiment, such aforementioned percentages may be based on the combined weight of the amine compound and the isocyanate compound. In one embodiment, such aforementioned percentages may be based on the combined moles of the amine compound and the isocyanate compound. In a further embodiment, such aforementioned percentages may be based on the weight of the isocyanate compound. In another further embodiment, such aforementioned percentages may be based on the moles of the isocyanate compound.

In one embodiment, such aforementioned percentages may be with respect to a first amine compound. For example, such amine compound may be one having the structure of formula (I), such as (Ia), (Ib), or (Ic), or (II). In particular, such amine compound may be one having the structure of formula (I), such as (Ia), (Ib), or (Ic), particularly formula (Ic). Furthermore, in one embodiment, such aforementioned percentages may be with respect to all amine compounds utilized in the formation of the polyurea.

The isocyanate compound may be provided in an amount of about 5% or more, such as 10% or more, such as 15% or more, such as 20% or more, such as 25% or more, such as 30% or more, such as 35% or more, such as 40% or more, such as 45% or more, such as 50% or more, such as 55% or more, such as 60% or more, such as 65% or more, such as 70% or more, such as 75% or more, such as 80% or more, such as 85% or more, such as 90% or more. The isocyanate compound may be provided in an amount of 95% or less, such as 90% or less, such as 85% or less, such as 80% or less, such as 75% or less, such as 70% or less, such as 65% or less, such as 60% or less, such as 55% or less, such as 50% or less, such as 45% or less, such as 40% or less, such as 35% or less, such as 30% or less, such as 25% or less, such as 20% or less, such as 15% or less, such as 10% or less. In one embodiment, such aforementioned percentages may be based on the combined weight of the amine compound and the isocyanate compound. In one embodiment, such aforementioned percentages may be based on the combined moles of the amine compound and the isocyanate compound. In a further embodiment, such aforementioned percentages may be based on the weight of the amine compound. In another further embodiment, such aforementioned percentages may be based on the moles of the amine compound.

In one embodiment, such aforementioned percentages may be with respect to a first amine compound. For example, such amine compound may be one having the structure of formula (I), such as (Ia), (Ib), or (lc), or (II). In particular, such amine compound may be one having the structure of formula (I), such as (Ia), (Ib), or (Ic), particularly formula (Ic). Furthermore, in one embodiment, such aforementioned percentages may be with respect to all amine compounds utilized in the formation of the polyurea.

In general, when an excess of one monomer is present, the polyurea may contain alternating monomers from the isocyanate compound and/or the amine compound with the urea linkage. However, both ends of the polyurea may be terminated based on the excess monomer. In one embodiment, the amine compound may be provided in excess such that the polyurea is amine terminated. In another embodiment, the isocyanate compound may be provided in excess such that the polyurea is isocyanate terminated.

The molecular weight of the polyurea may be controlled by controlling the compounds or monomers, in particular the size of the compounds or monomers and the various functional or substituent groups. Regardless, the molecular weight may be modified or adjusted to provide a desired solubility for a particular application taking into consideration the compounds or monomers as well as the solvent used.

In this regard, while not limited, the polyurea may have a particular molecular weight. For instance, the weight average molecular weight may be 100,000 g/mol or less, or 90,000 g/mol or less, or 80,000 g/mol or less, or 70,000 g/mol or less, or 60,000 g/mol or less, or 50,000 g/mol or less, or 40,000 g/mol or less, or 30,000 g/mol or less, or 20,000 g/mol or less. The weight average molecular weight may be 2,000 g/mol or more, such as 5,000 g/mol or more, such as 10,000 g/mol or more, such as 15,000 g/mol or more, such as 20,000 g/mol or more, such as 25,000 g/mol or more, such as 30,000 g/mol or more, such as 40,000 g/mol or more, such as 50,000 g/mol or more. The number average molecular weight may be 100,000 g/mol or less, or 90,000 g/mol or less, or 80,000 g/mol or less, or 70,000 g/mol or less, or 60,000 g/mol or less, or 50,000 g/mol or less, or 40,000 g/mol or less, or 30,000 g/mol or less, or 20,000 g/mol or less. The number average molecular weight may be 2,000 g/mol or more, such as 5,000 g/mol or more, such as 10,000 g/mol or more, such as 15,000 g/mol or more, such as 20,000 g/mol or more, such as 25,000 g/mol or more, such as 30,000 g/mol or more, such as 40,000 g/mol or more, such as 50,000 g/mol or more. The molecular weight may be determined using means generally known in the art, such as gel permeation chromatography.

In one embodiment, the polyurea may be formed without the use of a catalyst. For instance, the amine compound may react with the isocyanate compound without the use of a catalyst. Without intending to be limited, these catalysts may include, but are not limited to, an amine catalyst, an organometallic catalyst, etc. as well as mixtures thereof. In this regard, the catalyst may be provided in an amount of 0.1 wt. % or less, such as 0.05 wt. % or less, such as 0.01 wt. % or less, such as 0.005 wt. % or less, such as 0.001 wt. % or less, such as 0 wt. % based on the combined weight of the amine compound and the isocyanate compound. In one embodiment, the aforementioned weight percentages may apply based on the weight of the amine compound. In another embodiment, the aforementioned weight percentages may apply based on the weight of the isocyanate compound. Furthermore, the aforementioned weight percentages may apply to any single type of catalyst in one embodiment, such as an amine catalyst or an organometallic catalyst.

### Composition

The present disclosure may also be directed to a polyurea composition containing the polyurea as mentioned above. The present disclosure may also be directed to a prepolyurea composition or polyurea system, for example one including the amine compound and the isocyanate compound for forming the polyurea.

In the polyurea composition, the polyurea may be provided in an amount of 0.1 wt. % or more, such as 0.5 wt. % or more, such as 1 wt. % or more, such as 1.5 wt. % or more, such as 2 wt. % or more, such as 3 wt. % or more, such as 4 wt. % or more, such as 5 wt. % or more, such as 6 wt. % or more, such as 8 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more, such as 95 wt. % or more based on the weight of the composition. The polyurea may be provided in an amount of 95 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 12 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less, such as 1.8 wt. % or less, such as 1.5 wt. % or less, such as 1.3 wt. % or less, such as 1 wt. % or less based on the weight of the composition. In another embodiment, the aforementioned weight percentages may be based on the solids content of the composition.

In one embodiment, regarding a prepolyurea composition or polyurea system, such aforementioned weight percentages may apply to the combined weight of the amine compound and the isocyanate compound based on the weight of the prepolyurea composition or polyurea system. For instance, in the prepolyurea composition or polyurea system, the combined weight of the amine compound and the isocyanate compound may be an amount of 0.1 wt. % or more, such as 0.5 wt. % or more, such as 1 wt. % or more, such as 1.5 wt. % or more, such as 2 wt. % or more, such as 3 wt. % or more, such as 4 wt. % or more, such as 5 wt. % or more, such as 6 wt. % or more, such as 8 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more, such as 95 wt. % or more based on the weight of the composition. The combined weight may be an amount of 95 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 12 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less, such as 1.8 wt. % or less, such as 1.5 wt. % or less, such as 1.3 wt. % or less, such as 1 wt. % or less based on the weight of the composition.

In one embodiment, the respective composition and/or polyurea system may include a solvent. For instance, the solvent may include water, an organic solvent, or a mixture thereof. In one embodiment, the solvent may include water. In another embodiment, the solvent may include an organic solvent. In one embodiment, the solvent may include a mixture of water and an organic solvent.

The organic solvent may include an alcohol in one embodiment. In another embodiment, the solvent, in particular the organic solvent may include tetrahydrofuran, ethyl acetate, ether, dimethyl sulfoxide, dimethylformamide, acetone, methyl ethyl ketone, chloroform, dichloromethane, etc.

In the composition or polyurea system, the solvent may be provided in an amount of 0.1 wt. % or more, such as 0.5 wt. % or more, such as 1 wt. % or more, such as 1.5 wt. % or more, such as 2 wt. % or more, such as 3 wt. % or more, such as 4 wt. % or more, such as 5 wt. % or more, such as 6 wt. % or more, such as 8 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more, such as 95 wt. % or more based on the weight of the composition or polyurea system. The solvent may be provided in an amount of 95 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 12 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less, such as 1.8 wt. % or less, such as 1.5 wt. % or less, such as 1.3 wt. % or less, such as 1 wt. % or less based on the weight of the composition or polyurea system.

Removal of the solvent in one embodiment may reveal the polyurea. For instance, as an example, when forming a coating, the amine compound and the isocyanate compound may be provided as a prepolyurea composition or polyurea system. Further, they may be combined with a solvent. The solvent may be provided in the aforementioned amounts based on the weight of the composition or polyurea system in one embodiment. When provided as a polyurea system, the respective components may be mixed to form the prepolyurea composition. The composition may be provided to a substrate and the respective compounds may be allowed to react to form the coating.

The composition and/or polyurea system may also include a buffer, in particular an aqueous buffer, in one embodiment. The buffer may include those generally known in the art. For instance, the buffer may include an organic salt (e.g., carbonate salt, phosphate salt, etc.). The buffer may include an organic acid (e.g., acetic acid). In this regard, the buffer is not necessarily limited by the present disclosure.

Furthermore, the respective composition and/or polyurea system may include one or more other optional additives as generally known in the art. For instance, these may include, but are not limited to, wetting agents, colorants, pigments, thermoplastics, fillers (carbon fiber, glass fiber, glass spheres, high aspect ratio fillers, etc.), UV blocking compounds, UV stabilizers, coupling agents, fluorescent compounds, viscosity controlling agents, reactive and non-reactive diluents, etc. as well as mixtures thereof.

When utilized, they may be present in an amount of about 0.01 wt. % or more, such as about 0.05 wt. % or more, such as about 0.1 wt. % or more, such as about 0.2 wt. % or more, such as about 0.3 wt. % or more, such as about 0.5 wt. % or more, such as about 0.8 wt. % or more, such as about 1 wt. % or more, such as about 1.5 wt. % or more, such as about 2 wt. % or more, such as about 2.5 wt. % or more, such as about 3 wt. % or more, such as about 3.5 wt. % or more, such as about 4 wt. % or more, such as about 4.5 wt. % or more, such as about 5 wt. % or more, such as about 6 wt. % or more, such as about 7 wt. % or more, such as about 8 wt. % or more, such as about 9 wt. % or more, such as about 10 wt. % or more, such as about 12 wt. % or more, such as about 15 wt. % or more, such as about 18 wt. % or more, such as about 20 wt. % or more. They may be present in an amount of about 40 wt. % or less, such as about 38 wt. % or less, such as about 35 wt. % or less, such as about 33 wt. % or less, such as about 30 wt. % or less, such as about 27 wt. % or less, such as about 25 wt. % or less, such as about 23 wt. % or less, such as about 20 wt. % or less, such as about 17 wt. % or less, such as about 15 wt. % or less, such as about 13 wt. % or less, such as about 10 wt. % or less, such as about 8 wt. % or less, such as about 6 wt. % or less, such as about 5 wt. % or less, such as about 4.5 wt. % or less, such as about 4 wt. % or less, such as about 3.5 wt. % or less, such as about 3 wt. % or less, such as about 2.5 wt. % or less, such as about 2 wt. % or less, such as about 1.5 wt. % or less, such as about 1 wt. % or less, such as about 0.8 wt. % or less, such as about 0.6 wt. % or less, such as about 0.5 wt. % or less, such as about 0.4 wt. % or less, such as about 0.3 wt. % or less, such as about 0.1 wt. % or less. In one embodiment, such aforementioned weight percentages may be based on the weight of the polyurea. In another embodiment, such aforementioned weight percentages may apply based on the weight of the respective composition. In another embodiment, such aforementioned weight percentages may be based on the combined weight of the amine compound and the isocyanate compound. In a further embodiment, such aforementioned weight percentages may based on the weight of the polyurea system.

Such additives may be combined with the polyurea, to the extent able depending on the properties (e.g., viscosity, melt flow) of the polyurea, after synthesis of the polyurea. In another embodiment, the additives may be combined with the amine compound and the isocyanate compound, such as in a prepolyurea composition. Alternatively, the additives may be provided in the polyurea system for combining with the compounds in forming the polyurea. For instance, when forming the mixture of components for forming the polyurea, the additives may also be provided to such mixture and composition. As a result, such additives may be present upon formation of the polyurea and thus present in the polyurea. Thus, when applying or utilizing the polyurea for a particular application, such additives may already be present. When the composition is provided with a solvent and includes such additives, removal of the solvent may yield a composition including the polyurea and such additives.

### Applications

The application of the polyurea and any corresponding composition is not necessarily limited by the present invention. For instance, the polyurea as disclosed herein may be utilized in a variety of applications for a number of industries and is thus not limited by the present disclosure in that regard. Without intending to be limited, the industry may be the electronics industry, electrical industry, aerospace industry, automotive industry, sporting industry, appliance/home goods industry, consumer goods industry, apparel/footwear industry, etc. In addition, the polyurea may be utilized in applications related to coatings, composites, adhesives, laminates, foams, sealants, elastomers, etc.

In this regard, the present disclosure may also be directed to an article including the polyurea. For instance, the article may comprise a coating, a composite, an adhesive, a laminate, or a foam made from the polyurea. In one embodiment, the article may comprise a coating made from the polyurea. In another embodiment, the article may comprise a composite made from the polyurea. In a further embodiment, the article may comprise an adhesive made from the polyurea. In another further embodiment, the article may comprise a laminate made from the polyurea. In another embodiment, the article may comprise a foam made from the polyurea.

One particular application is the formation of a coating on a substrate. For such application, a polyurea composition or prepolyurea composition as defined herein may be applied to a substrate. The substrate may be a metal, a plastic, a ceramic, glass, or natural materials, such as wood. In this regard, the substrate is not necessarily limited by the present disclosure. The coating may be a for a single layer coating or a multilayer coating. Regarding the latter, multiple steps of providing the respective composition may be conducted for forming the multilayer coating. Further, the composition may be provided by spraying, painting, immersing, rolling, brushing, pouring, etc. or any other means as generally known in the art. Any solvent present may be removed, such as by evaporation, for providing the polyurea coating on the substrate. Related, if the components are provided in a prepolyurea composition or polyurea system, the components may be reacted to form the polyurea which may form as a coating on the substrate. In this regard, such components may be provided directly on the substrate on which the polymerization/curing may be conducted and the polyurea may be formed.

### EXAMPLES

### Test Method

Lap Shear Modulus: The lap shear modulus was determined at 23ºC according to ASTM D3163-01(2014) using aluminum substrates or polyvinyl chloride substrates. For the test, a polyurea was formed on a substrate. The substrates were 1.5 mm thick, the polyurea was 0.2 mm thick, and the bonding area was 25 mm×10 mm. The overlap was 2.5 cm between the pair of substrates. The test speed was 10 mm/min.

### Example 1

A first amine compound, N,N-bis-(1,4-dimethylpentyl)-p-phenylenediamine, and a second amine compound, 4,4′-methylenebis[N-sec-butylaniline], were utilized to prepare a polyurea. The prepolymer was a diphenylmethane diisocyanate polyurea prepolymer and the curative includes diethyltoluenediamine (25 wt. %), polyoxypropylenetriamine (68 wt. %), and either N, N-bis-(1,4-dimethylpentyl)-p-phenylenediamine or 4,4′-methylenebis[N-sec-butylaniline] (7 wt. %). The ratio of NCO to the amine and OH was one to one. The respective samples were cured with the polyurea adhesive between two substrates (“Al”—aluminum substrates; “PVC”—polyvinylchloride substrates) for various curing times and temperatures.

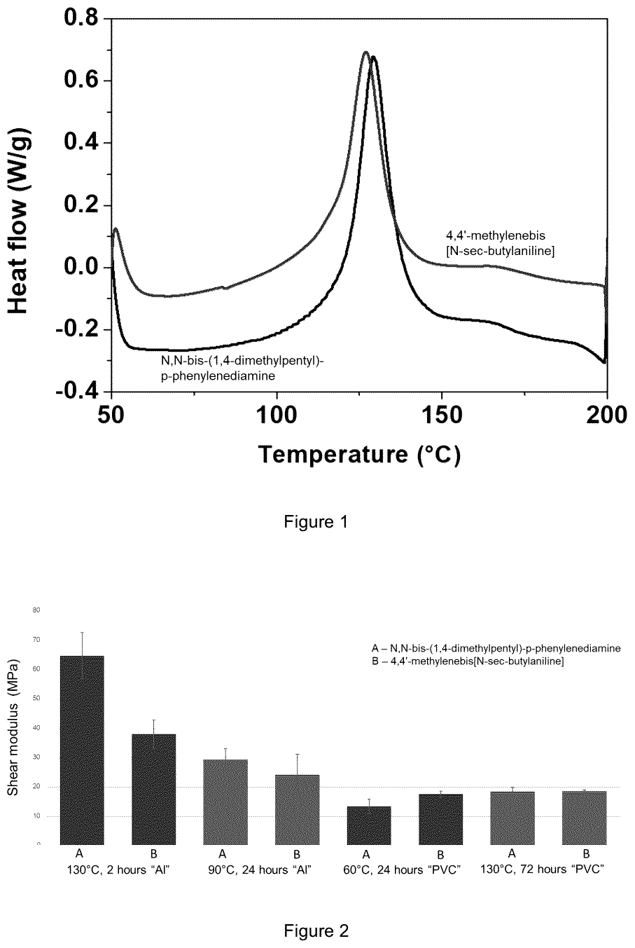

FIG. 1 shows a graph comparing the reactivity of N,N-bis-(1,4-dimethylpentyl)-p-phenylenediamine and 4,4′-methylenebis[N-sec-butylaniline]. The N, N-bis-(1,4-dimethylpentyl)-p-phenylenediamine reacted more slowly than the commercial amine, which is preferable, and N,N-bis-(1,4-dimethylpentyl)-p-phenylenediamine's heat flow peak appeared to cure at a higher temperature, which is also preferable because slower reactivity generally means a wider operation window.

FIG. 2 depicts the shear modulus of the samples. In particular, the bar graph of FIG. 2 shows that N,N-bis-(1,4-dimethylpentyl)-p-phenylenediamine has a shear modulus that is 50% higher than 4,4′-methylenebis[N-sec-butylaniline] at 130° C. for 2 hours. When deformation is the same, a higher shear modulus generally means the material can withstand a higher force. Compared to 4,4′-methylenebis[N-sec-butylaniline], it is believed that N,N-bis-(1,4-dimethylpentyl)-p-phenylenediamine offers a longer operation window and stronger adhesion. Although only aluminum and PVC were tested, it is believed that N,N-bis-(1,4-dimethylpentyl)-p-phenylenediamine's adhesive properties may also be applicable to stainless steel, glass, and copper as well.

These and other modifications and variations of the present disclosure may be practiced by those of ordinary skill in the art, without departing from the spirit and scope of the present disclosure. In addition, it should be understood that aspects of the various embodiments may be interchanged both in whole or in part. Furthermore, those of ordinary skill in the art will appreciate that the foregoing description is by way of example only and is not intended to limit the disclosure so further described in such appended claims.

What is claimed is:

1. A method of synthesizing a polyurea, the method comprising:
providing a mixture of an isocyanate compound comprising a diisocyanate and an amine compound comprising a diamine wherein at least one amine group of the diamine is a secondary amine and further wherein the amine compound has the following structure: 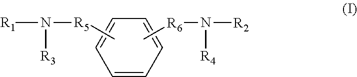
wherein
R₁ and R₂ are independently hydrogen, alkyl or aryl;
R₃ and R₄ are independently hydrogen or alkyl;
R₅ and R₆ are independently a direct bond or a divalent radical;
heating the mixture to a temperature to effect a reaction between the isocyanate compound and the amine compound.

2. The method of claim 1, wherein R₁ and R₂ are independently alkyl or aryl and R₅ and R₆ are a direct bond.

3. The method of claim 1, wherein each amine group of the diamine is a secondary amine.

4. The method of claim 1, wherein the diamine comprises N,N′-diphenyl-p-phenylenediamine; N,N-bis-(1,4-dimethylpentyl)-p-phenylenediamine; 1,4-benzenediamine, N,N′-mixed phenyl and tolyl derivatives; N-isopropyl-N′-phenyl-1,4-phenylenediamine; bis(2,2,6,6tetramethyl-4-piperidyl) sebacate; bis(1,2,2,6,6pentamethyl-4-piperidyl) sebacate; N-(1,4-dimethylpentyl)-1,4-benzenediamine; N-1,3-dimethylbutyl-N′-phenyl-p-phenylenediamine; N,N′-di-2-butyl-1,4-phenylenediamine; N-1-(1,4-dimethylpentyl)-1,4-benzenediamine; or a mixture thereof.

5. The method of claim 1, wherein the amine compound comprises N,N-bis-(1,4-dimethylpentyl)-p-phenylenediamine.

6. The method of claim 1, wherein the amine compound has the following structure: 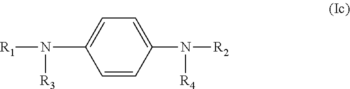
wherein
R₁ and R₂ are independently alkyl or aryl; and
R₃ and R₄ are independently hydrogen or alkyl.

7. The method of claim 1, wherein the mixture further comprises a second amine compound.

8. The method of claim 7, wherein the second amine compound comprises a polyoxyalkylene amine and/or an alkyl diamine.

9. The method of claim 7, wherein the second amine comprises a polyoxyalkylene amine an alkyl diamine.

10. The method of claim 1, wherein the isocyanate compound comprises an aliphatic isocyanate, a cycloaliphatic isocyanate, an aromatic isocyanate, or a mixture thereof.

11. The method of claim 1, wherein the isocyanate compound comprises hexane diisocyanate, isophorone diisocyanate, naphthalene diisocyanate, toluene-2,4-diisocyanate, toluene-2,6-diisocyanate, methylenediphenyldiisocyanate, p-phenylenediisocyanate, meta-trimethylxylylenediisocyanate, methylene-bis(4-cyclohexylisocyanate), tetramethylxylylene diisocyanate, hydrogenated methylenediphenyldiisocyanate or a mixture thereof.

12. The method of claim 1, wherein the isocyanate compound comprises methylenediphenyldiisocyanate.

13. The method of claim 1, wherein the isocyanate compound comprises an oligomeric polyisocyanate.

14. The method of claim 1, wherein the isocyanate compound comprises an isocyanate prepolymer including two isocyanate groups.

15. The method of claim 1, wherein the temperature is 20° C. or more to 250° C. or less.

16. The method of claim 1, wherein the polyurea exhibits a Shore D hardness of from 40 to 100 as determined in accordance with ASTM D2240-15 (2021).

17. The method of claim 1, wherein the polyurea exhibits a lap shear modulus of 40 MPa or more to 150 MPa or less as determined in accordance with ASTM D3163-01(2014) using an aluminum substrate and wherein the polyurea is synthesized at a temperature of 130° C. and a reaction time of 2 hours and/or wherein the polyurea exhibits a lap shear modulus of 25 MPa or more to 100 MPa or less as determined in accordance with ASTM D3163-01(2014) using an aluminum substrate and wherein the polyurea is synthesized at a temperature of 90° C. and a reaction time of 24 hours.

18. A polyurea formed from the method of claim 1.

19. A coating containing the polyurea of claim 18.

20. A polyurea system comprising an isocyanate compound comprising a diisocyanate and an amine compound comprising a diamine wherein at least one amine group of the diamine is a secondary amine and further wherein the amine compound has the following structure: 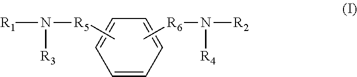
wherein
R₁ and R₂ are independently hydrogen, alkyl or aryl;
R₃ and R₄ are independently hydrogen or alkyl;
R₅ and R₆ are independently a direct bond or a divalent radical.
